(19) United States
(12) Patent Application Publication
(10) Pub. No.: US 2012/0093599 A1
(43) Pub. Date: Apr. 19, 2012

(54) CUTTING TOOL

(76) Inventors: Thomas Evatt, Six Mile, SC (US); Jim Pangerc, Williamston, SC (US)

(21) Appl. No.: 13/214,660

(22) Filed: Aug. 22, 2011

Related U.S. Application Data
(60) Provisional application No. 61/393,219, filed on Oct. 14, 2010.

(51) Int. Cl. B23B 51/04

(52) U.S. Cl. 408/204

(57) ABSTRACT

A rotary cutting tool for use with a power tool includes a generally cylindrical body having a closed end and an open end, and a cutting portion formed at the open end of the generally cylindrical body. The cutting portion includes a plurality of main tooth bodies and a plurality of main gullet areas formed between the plurality of main tooth bodies. Each main tooth body includes a first secondary tooth having a first tip, a second secondary tooth having a second tip and a similar shape and size to the first secondary tooth, and a secondary gullet area formed between the first secondary tooth and the second secondary tooth. Each main gullet area is generally larger than each secondary gullet area. Each main tooth body only includes a single first secondary tooth and a single second secondary tooth.

### CROSS-REFERENCE TO RELATED APPLICATIONS

This application claims priority to U.S. Provisional Patent Application No. 61/393,219, filed Oct. 14, 2010, the entire contents of which are hereby incorporated by reference.

### BACKGROUND

The present invention relates to cutting tools and, more particularly, to rotary cutting tools for use with power tools.

Rotary cutting tools for power tools provide users the ability to quickly and efficiently cut holes in a work piece. The tooth form on a rotary cutting tool is a major factor in the durability, cost, cut speed, and cut quality of the rotary cutting tool. The tooth forms on current rotary cutting tools are a limiting factor in the effectiveness of the tool.

### SUMMARY

In one embodiment, the invention provides a rotary cutting tool for use with a power tool. The rotary cutting tool includes a generally cylindrical body having a closed end and an open end, and a cutting portion formed at the open end of the generally cylindrical body. The cutting portion includes a plurality of main tooth bodies and a plurality of main gullet areas formed between the plurality of main tooth bodies. Each main tooth body includes a first secondary tooth having a first tip, a second secondary tooth having a second tip and a similar shape and size to the first secondary tooth, and a secondary gullet area formed between the first secondary tooth and the second secondary tooth. Each main gullet area is generally larger than each secondary gullet area. Each main tooth body only includes a single first secondary tooth and a single second secondary tooth.

In another embodiment, the invention provides a rotary cutting tool for use with a power tool. The rotary cutting tool includes a generally cylindrical body having a closed end and an open end, and a cutting portion formed at the open end of the generally cylindrical body. The cutting portion includes a plurality of main tooth bodies and a plurality of main gullet areas formed between the plurality of main tooth bodies. Each main tooth body includes a first secondary tooth having a first tip, a second secondary tooth having a second tip, and a secondary gullet area formed between the first secondary tooth and the second secondary tooth. Each main gullet area has a first depth measured from the first tip of a corresponding first secondary tooth to a base surface of the main gullet area. Each secondary gullet area has a second depth measured from the second tip of a corresponding second secondary tooth to a base surface of the secondary gullet area. A ratio of the second depth to the first depth is between approximately 0.7 and approximately 0.8.

In yet another embodiment, the invention provides a rotary cutting tool for use with a power tool, the rotary cutting tool includes a generally cylindrical body having a closed end and an open end, and a cutting portion formed at the open end of the generally cylindrical body. The cutting portion includes a plurality of main tooth bodies and a plurality of main gullet areas formed between the plurality of main tooth bodies. Each main tooth body includes a first secondary tooth having a first tip, a second secondary tooth having a second tip, and a secondary gullet area formed between the first secondary tooth and the second secondary tooth. Each main gullet area is generally larger than each secondary gullet area. The first secondary tooth and the second secondary tooth on each main tooth body are separated by a first tooth pitch measured from the first tip of the first secondary tooth to the second tip of the second secondary tooth. The first secondary tooth on one main tooth body and the first secondary tooth on an adjacent main tooth body are separated by a second tooth pitch measured from the first tip of the first secondary tooth on the one main tooth body to the first tip of the first secondary tooth on the adjacent main tooth body. Wherein a ratio of the first tooth pitch to the second tooth pitch is between approximately 0.3 and approximately 0.5.

Other aspects of the invention will become apparent by consideration of the description and accompanying drawings.

### BRIEF DESCRIPTION OF THE DRAWINGS

FIG. 1 is a partial sectional view of a rotary cutting tool according to one embodiment of the invention.

FIG. 2 is an enlarged side view of a portion of a tooth form of the rotary cutting tool shown in FIG. 1.

FIG. 3 is a top view of a portion of the rotary cutting tool shown in FIG. 1.

FIG. 4 is a cross-sectional view of a portion of the rotary cutting tool taken along section line 4-4 of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

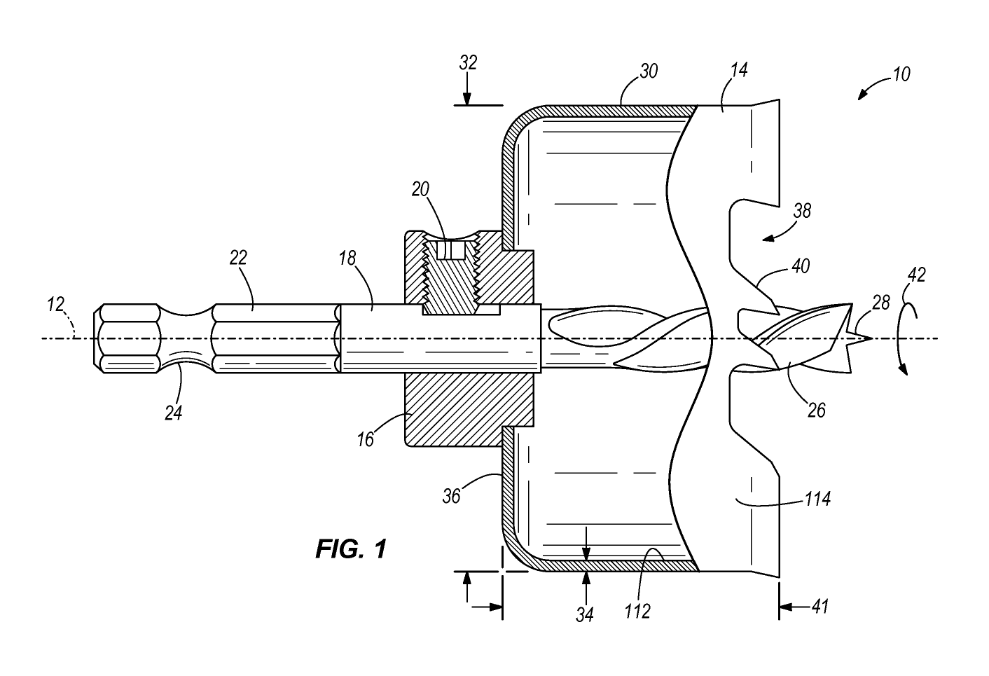

FIG. 1 illustrates a rotary cutting tool 10 for releasable connection to a rotary power tool (not shown) such as, for example, a drill. The rotary cutting tool 10 defines a longitudinal axis 12 and includes a coaxial hole saw 14, a coaxial arbor 16, and a coaxial brad point drill bit 18. The arbor 16 removably mounts the hole saw 14 to the brad point drill bit 18 by way of a mounting screw 20. The brad point drill bit 18 includes a hex shank portion 22 with a circumferential groove 24 for attaching to the rotary power tool, and a drill bit portion 26 with a brad point 28 for drilling holes. The drill bit portion 26 tapers from the brad point 28 toward the shank portion 22 such that the brad point drill bit 18 has a larger diameter at the drill portion 26 than at the shank portion 22. In the illustrated embodiment, the brad point drill bit 18 is approximately 80.0 mm long and approximately 7.0 mm diameter at the drill bit portion 26 with a diameter of approximately 6.0 mm at the hex shank portion 22. In other embodiments, the drill bit portion 26 and/or the shank portion 22 may have relatively larger or smaller diameters. In a further embodiment, the shank portion 22 may be separate from the drill bit portion 26.

The hole saw 14 has a generally cylindrical shape and includes a hole saw body 30 having a diameter 32, a thickness 34, a closed end 36 where the arbor 16 joins the hole saw 14 to the drill bit 18, an open end 38 having a cutting portion 40, and a length 41 measured from the closed end 36 to the open end 38. As shown in FIG. 1, the drill portion 26 of the drill bit 18 extends through a center of the hole saw body 30 past the open end 38 and the cutting portion 40. During operation, the rotary cutting tool 10 rotates about the longitudinal axis 12 in a cutting direction 42. In the illustrated embodiment, the thickness 34 of the hole saw body 30 is approximately 1.09 mm. In other embodiments, the thickness 34 may be relatively larger or smaller.

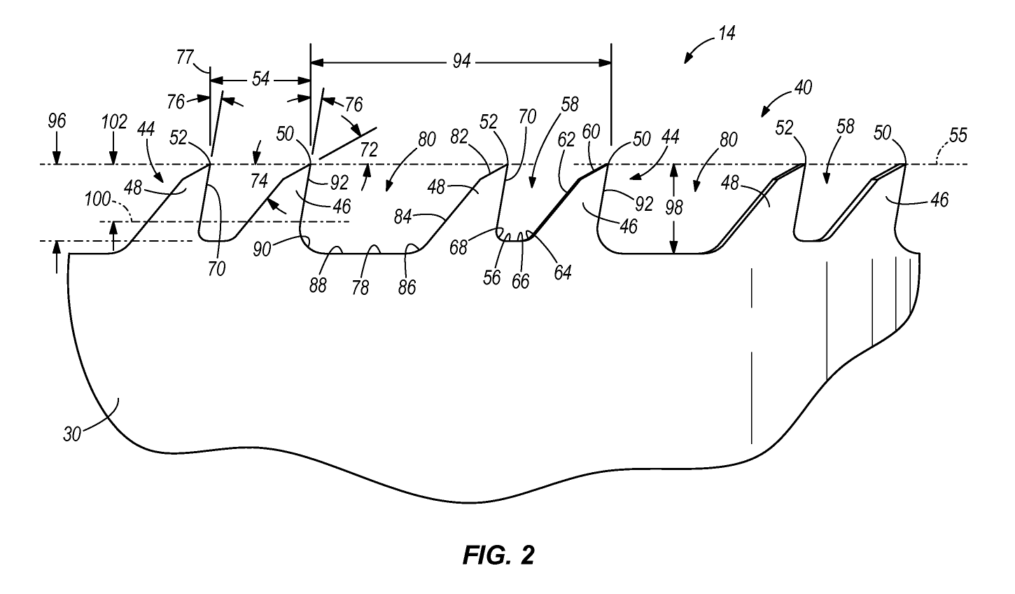

Referring to FIG. 2, the illustrated cutting portion 40 defines a repeating tooth form. The tooth form includes a main tooth body 44, a first secondary tooth 46 formed on the main tooth body 44, and a second secondary tooth 48 formed on the main tooth body 44. The first secondary teeth 46 and the second secondary teeth 48 generally have a similar shape and size. In other embodiments, fewer or more secondary teeth may be formed on each main tooth body 44. The number of main tooth bodies 44 on the hole saw 14 varies with the diameter 32 of the hole saw 14. For example, in various embodiments, the cutting portion 40 of the hole saw 14 includes six to twelve main tooth bodies 44. As discussed below, the secondary teeth 46, 48 are bent or “set” at angles relative to the hole saw body 30 and the main tooth bodies 44. The distances and measurements herein made for the tooth form are made relative to the teeth 46, 48 before they are set.

The first secondary tooth 46 and the second secondary tooth 48 each include respective tooth tips 50, 52. The tooth tips 50, 52 are separated by a secondary tooth pitch 54. In the illustrated embodiment, the secondary tooth pitch 54 is approximately 5.6 mm. In other embodiments, the secondary tooth pitch 54 may be relatively larger or smaller. The tips 50 of the first secondary teeth 46 and the tips 52 of the second secondary teeth 48 are all at generally the same height and define a first plane 55 that is normal to the longitudinal axis 12.

On each main tooth body 44, a first curvilinear surface 56 extends between the tip 50 of first secondary tooth 46 and the tip 52 of the second secondary tooth 48 and defines a secondary tooth gullet area 58. The secondary tooth gullet area 58 is defined by a primary relief surface 60 of the first secondary tooth 46, a secondary relief surface 62 of the first secondary tooth 46, a first gullet radius 64, a base surface 66, a second gullet radius 68, and a rake face 70 of the second secondary tooth 48.

The primary relief surface 60 extends from the first secondary tooth tip 50 at a primary relief angle 72 measured relative to the first plane 55 that extends through the tips 50, 52 of the secondary teeth 46, 48. The secondary relief surface 62 extends at a secondary relief angle 74 measured relative to the first plane 55. In the illustrated embodiment, the primary relief angle 72 is approximately 30 degrees and the secondary relief angle 74 is approximately 50 degrees. In other embodiments, the primary relief angle 72 and the secondary relief angle 74 may be relatively larger or smaller. The rake face 70 of the second secondary tooth 48 extends from the tip 52 at a rake angle 76 measured relative to a second plane 77 that is parallel to the longitudinal axis 12 and normal to the first plane 55. In the illustrated embodiment, the rake angle 76 is between approximately 3 degrees and approximately 10 degrees. In other embodiments, the rake angle 76 may be relatively larger or smaller. In the illustrated embodiment, the first and second gullet radiuses 64, 68 are both approximately 0.75 mm. In other embodiments, the first and second gullet radiuses 64, 68 may be relatively larger or smaller.

A second curvilinear surface 78 extends between the tip 52 of the second secondary tooth 48 on one main tooth body 44 and the tip 50 of the first secondary tooth 46 on an adjacent main tooth body 44. The second curvilinear surface 78 defines a main tooth gullet area 80. The main tooth gullet area 80 is defined by a primary relief surface 82 of the second secondary tooth 48, a secondary relief surface 84 of the second secondary tooth 48, a first gullet radius 86, a base surface 88, a second gullet radius 90, and a rake face 92 of the adjacent first secondary tooth 46. As shown in FIG. 1, each main tooth gullet area 80 extends less than 20% of the length 41 of the hole saw body 30 toward the closed end 36 of the hole saw 14. In the illustrated embodiment, each main tooth gullet area 80 extends between approximately 12% and approximately 14% of the length 41 of the hole saw body 30.

As shown in FIG. 2, in the illustrated embodiment, the primary relief surface 82 extends from the second secondary tooth tip 52 at the same primary relief angle 72 (e.g., approximately 30 degrees) as the primary relief surface 60 of the first tooth 46. Similarly, the secondary relief surface 84 extends at the same secondary relief angle 74 (e.g., approximately 50 degrees) as the secondary relief surface 62 of the first secondary tooth 46. In other embodiments, the first tooth 46 and the second tooth 48 may have primary relief surfaces and secondary relief surfaces that extend at different relief angles. In the illustrated embodiment, the rake face 92 of the first secondary tooth 46 on the adjacent main tooth body 44 extends from the tip 50 at the same rake angle 76 (e.g., between approximately 3 degrees and approximately 10 degrees) as the rake face 70 of the second secondary tooth 48. In other embodiments, the first secondary tooth 46 and the second secondary tooth 48 may have rake faces that extend at different rake angles. As noted in Table 1 below, in various embodiments, the first and second gullet radiuses 86, 90 are both between approximately 1.0 mm and 1.5 mm. In other embodiments, the first and second gullet radiuses 86, 90 may be relatively larger or smaller.

As shown in FIG. 2, the first secondary tooth 46 on one main tooth body 44 and the first secondary tooth 46 on the adjacent main tooth body 44 are separated by a main tooth pitch 94. The main tooth pitch 94 varies depending on the diameter 32 of the hole saw 14 and the number of main tooth bodies 44 formed in the body 30. As noted in Table 1 below, in various embodiments, the main tooth pitch 94 of the hole saw 14 is between approximately 12.35 mm and approximately 16.65 mm. In such embodiments, a ratio of the secondary tooth pitch 54 to the main tooth pitch 94 is between approximately 0.3 and approximately 0.5 and, more particularly, between approximately 0.34 and approximately 0.45.

Each secondary tooth gullet area 58 has a gullet depth 96 (i.e., a secondary tooth height) measured from the base surface 66 of the first curvilinear surface 56 to the first plane 55 or the second secondary tooth tip 52. In the illustrated embodiment, the gullet depth 96 is approximately 2.8 mm. In other embodiments, the gullet depth 96 may be relatively larger or smaller. Similarly, each main tooth gullet area 80 has a gullet depth 98 (i.e., a main tooth height) measured from the base surface 88 of the second curvilinear surface 78 to the first plane 55 or the first secondary tooth tip 50. As noted in Table 1 below, in various embodiments, the main gullet depth 98 is between approximately 3.5 mm and approximately 4.0 mm. In such embodiments, a ratio of the secondary gullet depth 96 to the main gullet depth 98 is between approximately 0.7 and approximately 0.8.

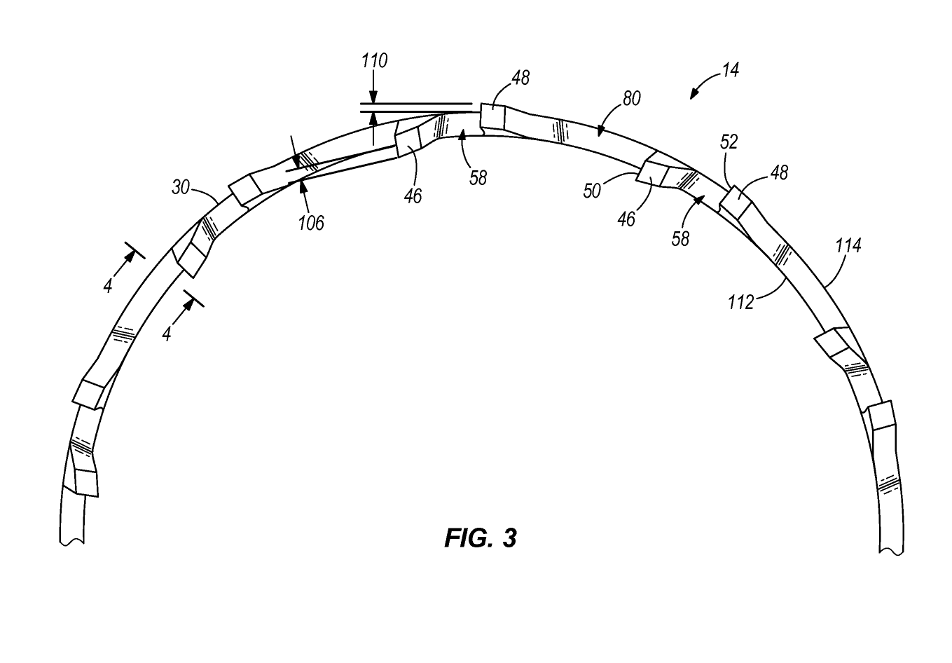

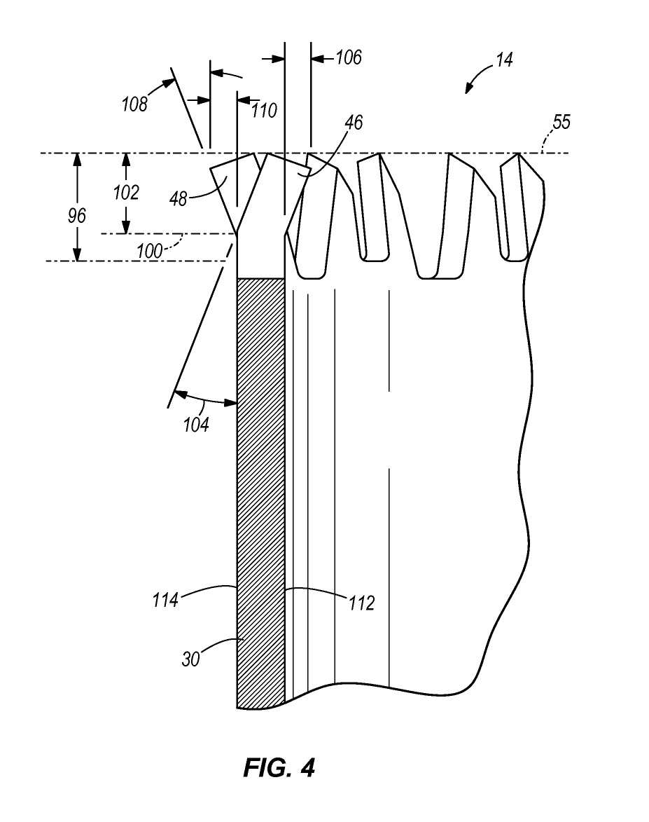

Referring to FIGS. 3 and 4, the first and second secondary teeth 46, 48 are bent, or set, relative to the hole saw body 30 along a bend line 100. The bend line 100 lies a distance 102 from the first plane 55. In the illustrated embodiment, the bend line 100 is spaced approximately 2.54 mm from the first plane 55. Each first secondary tooth 46 is bent at a first bend angle or set angle 104 toward an interior of the hole saw 14 in the direction of the longitudinal axis 12. The first set angle 104 is measured relative to the hole saw body 30. The first set angle 104 displaces the tip 50 a first set magnitude 106, measured relative to an interior surface 112 of the hole saw body 30. In the illustrated embodiment, the set magnitude 106 is between approximately 1.0 mm and approximately 1.5 mm and the first set angle 104 is between approximately 23 degrees and approximately 37 degrees. In other embodiments, the first set angle 104 and the set magnitude 106 may be relatively larger or smaller. Each second secondary tooth 48 is bent outward in the opposite direction of the first secondary tooth 46 at a second bend angle or set angle 108. The second set angle 108 is measured relative to the hole saw body 30. The second set angle displaces the tip 52 a second set magnitude 110, measured relative to an exterior surface 114 of the hole saw body 30. In the illustrated embodiment, the set magnitude 110 is between approximately 0.5 mm and approximately 0.8 mm and the second set angle 108 is between approximately 11 degrees and approximately 19 degrees. In other embodiments, the second set angle 108 and the set magnitude 110 may be relatively larger or smaller.

Dimensions of the hole saw tooth form vary according to the diameter 32 (FIG. 1) of the hole saw 14. Examples of various hole saw dimensions are provided below in Table 1.

TABLE 1

| | Main Gullet | Rake | Main Tooth | | Number | |
|---|---|---|---|---|---|---|
| Hole Saw | Depth/Tooth | Angle | Gullet | Main Tooth | of Main | Number of |
| Diameter (32) | Height (98) | (76) | Radius (86, | Pitch (94) | Tooth | Secondary |
| (+/−0.5 mm) | (+/−0.2 mm) | (degrees) | 90) (mm) | (+/−0.2 mm) | Bodies | Teeth |
| 25.0 mm | 3.5 mm | 3 | 1.0 | 12.35 mm | 6 | 12 |
| 32.0 mm | 4.0 mm | 5 | 1.0 | 14.0 mm | 7 | 14 |
| 38.0 mm | 4.0 mm | 5 | 1.0 | 14.59 mm | 8 | 16 |
| 44.0 mm | 4.0 mm | 10 | 1.5 | 16.65 mm | 8 | 16 |
| 51.0 mm | 4.0 mm | 10 | 1.5 | 17.33 mm | 9 | 18 |
| 54.0 mm | 4.0 mm | 10 | 1.5 | 16.65 mm | 10 | 20 |
| 57.0 mm | 4.0 mm | 10 | 1.5 | 15.99 mm | 11 | 22 |
| 64.0 mm | 4.0 mm | 10 | 1.5 | 16.65 mm | 12 | 24 |

Although the cutting tool tooth form has been described with respect to a hole saw for use with a rotary power tool, the tooth form may be used on other types of saw blades having a linear edge, including band saw blades, reciprocating saw blades, and jig saw blades.

It should be noted that the dimensions used herein are used for exemplary purposes only. Other constructions may vary the dimensions as required for the particular application. As such, the invention should not be limited by the dimensions provided herein.

Although particular constructions embodying independent aspects of the present invention have been shown and described, other alternative constructions will become apparent to those skilled in the art and are within the intended scope of the independent aspects of the invention.

1. A rotary cutting tool for use with a power tool, the rotary cutting tool comprising:
a generally cylindrical body having a closed end and an open end; and
a cutting portion formed at the open end of the generally cylindrical body, the cutting portion including a plurality of main tooth bodies and a plurality of main gullet areas formed between the plurality of main tooth bodies, each main tooth body including a first secondary tooth having a first tip, a second secondary tooth having a second tip and a similar shape and size to the first secondary tooth, and a secondary gullet area formed between the first secondary tooth and the second secondary tooth;
wherein each main gullet area is generally larger than each secondary gullet area, and wherein each main tooth body only includes a single first secondary tooth and a single second secondary tooth.

2. The rotary cutting tool of claim 1, wherein each first secondary tooth has a rake face extending from the first tip at a first rake angle to partially define a corresponding main gullet area, wherein each second secondary tooth has a rake face extending from the second tip at a second rake angle to partially define a corresponding secondary gullet area, and wherein the first rake angle is generally equal to the second rake angle.

3. The rotary cutting tool of claim 1, wherein each first secondary tooth has a relief face extending from the first tip at a first relief angle to partially define a corresponding secondary gullet area, wherein each second secondary tooth has a relief face extending from the second tip at a second relief angle to partially define a corresponding main gullet area, and wherein the first relief angle is generally equal to the second relief angle.

4. The rotary cutting tool of claim 1, wherein one of the first secondary tooth and the second secondary tooth on each main tooth body is set in a first direction such that one of the first tip and the second tip is displaced inwardly of the generally cylindrical body, and wherein the other of the first secondary tooth and the second secondary tooth on each main tooth body is set in a second direction such that the other of the first tip and the second tip is displaced outwardly of the generally cylindrical body.

5. The rotary cutting tool of claim 1, wherein the cutting portion includes six to twelve main tooth bodies and six to twelve main gullet areas.

6. The rotary cutting tool of claim 1, wherein each main gullet area has a first depth measured from the first tip of a corresponding first secondary tooth to a base surface of the main gullet area, wherein each secondary gullet area has a second depth measured from the second tip of a corresponding second secondary tooth to a base surface of the secondary gullet area, and wherein a ratio of the second depth to the first depth is between approximately 0.7 and approximately 0.8.

7. The rotary cutting tool of claim 1, wherein the first secondary tooth and the second secondary tooth on each main tooth body are separated by a first tooth pitch measured from the first tip of the first secondary tooth to the second tip of the second secondary tooth, wherein the first secondary tooth on one main tooth body and the first secondary tooth on an adjacent main tooth body are separated by a second pitch measured from the first tip of the first secondary tooth on the one main tooth body to the first tip of the first secondary tooth on the adjacent main tooth body, and wherein a ratio of the first tooth pitch to the second tooth pitch is between approximately 0.3 and approximately 0.5.

8. The rotary cutting tool of claim 1, wherein the first tip of each first secondary tooth and the second tip of each second secondary tooth define a plane.

9. The rotary cutting tool of claim 8, further comprising a brad point bit, wherein the brad point bit extends through a center of the generally cylindrical body past the plane.

10. The rotary cutting tool of claim 9, wherein the brad point bit includes a drill bit portion having a brad point and a shank portion configured to couple to the power tool, and wherein the drill bit portion tapers from the brad point toward the shank portion.

11. A rotary cutting tool for use with a power tool, the rotary cutting tool comprising:
a generally cylindrical body having a closed end and an open end; and
a cutting portion formed at the open end of the generally cylindrical body, the cutting portion including a plurality of main tooth bodies and a plurality of main gullet areas formed between the plurality of main tooth bodies, each main tooth body including a first secondary tooth having a first tip, a second secondary tooth having a second tip, and a secondary gullet area formed between the first secondary tooth and the second secondary tooth;
wherein each main gullet area has a first depth measured from the first tip of a corresponding first secondary tooth to a base surface of the main gullet area, wherein each secondary gullet area has a second depth measured from the second tip of a corresponding second secondary tooth to a base surface of the secondary gullet area, and wherein a ratio of the second depth to the first depth is between approximately 0.7 and approximately 0.8.

12. The rotary cutting tool of claim 11, wherein the first tip of each first secondary tooth and the second tip of each second secondary tooth define a plane.

13. The rotary cutting tool of claim 11, wherein each first secondary tooth has a rake face extending from the first tip at a first rake angle to partially define a corresponding main gullet area and a relief face extending from the first tip at a first relief angle to partially define a corresponding secondary gullet area, wherein each second secondary tooth has a rake face extending from the second tip at a second rake angle to partially define a corresponding secondary gullet area and a relief face extending from the second tip at a second relief angle to partially define a corresponding main gullet area, and wherein the first rake angle is generally equal to the second rake angle and the first relief angle is generally equal to the second relief angle.

14. The rotary cutting tool of claim 11, wherein one of the first secondary tooth and the second secondary tooth on each main tooth body is set in a first direction such that one of the first tip and the second tip is displaced inwardly of the generally cylindrical body, and wherein the other of the first secondary tooth and the second secondary tooth on each main tooth body is set in a second direction such that the other of the first tip and the second tip is displaced outwardly of the generally cylindrical body.

15. The rotary cutting tool of claim 11, wherein the cutting portion includes six to twelve main tooth bodies and six to twelve main gullet areas.

16. A rotary cutting tool for use with a power tool, the rotary cutting tool comprising:
a generally cylindrical body having a closed end and an open end; and
a cutting portion formed at the open end of the generally cylindrical body, the cutting portion including a plurality of main tooth bodies and a plurality of main gullet areas formed between the plurality of main tooth bodies, each main tooth body including a first secondary tooth having a first tip, a second secondary tooth having a second tip, and a secondary gullet area formed between the first secondary tooth and the second secondary tooth;
wherein each main gullet area is generally larger than each secondary gullet area;
wherein the first secondary tooth and the second secondary tooth on each main tooth body are separated by a first tooth pitch measured from the first tip of the first secondary tooth to the second tip of the second secondary tooth, wherein the first secondary tooth on one main tooth body and the first secondary tooth on an adjacent main tooth body are separated by a second tooth pitch measured from the first tip of the first secondary tooth on the one main tooth body to the first tip of the first secondary tooth on the adjacent main tooth body, and wherein a ratio of the first tooth pitch to the second tooth pitch is between approximately 0.3 and approximately 0.5.

17. The rotary cutting tool of claim 16, wherein the first tip of each first secondary tooth and the second tip of each second secondary tooth define a plane.

18. The rotary cutting tool of claim 16, wherein each first secondary tooth has a rake face extending from the first tip at a first rake angle to partially define a corresponding main gullet area and a relief face extending from the first tip at a first relief angle to partially define a corresponding secondary gullet area, wherein each second secondary tooth has a rake face extending from the second tip at a second rake angle to partially define a corresponding secondary gullet area and a relief face extending from the second tip at a second relief angle to partially define a corresponding main gullet area, and wherein the first rake angle is generally equal to the second rake angle and the first relief angle is generally equal to the second relief angle.

19. The rotary cutting tool of claim 16, wherein one of the first secondary tooth and the second secondary tooth on each main tooth body is set in a first direction such that one of the first tip and the second tip is displaced inwardly of the generally cylindrical body, and wherein the other of the first secondary tooth and the second secondary tooth on each main tooth body is set in a second direction such that the other of the first tip and the second tip is displaced outwardly of the generally cylindrical body.

20. The rotary cutting tool of claim 16, wherein the cutting portion includes six to twelve main tooth bodies and six to twelve main gullet areas.
